(19) United States
(12) Patent Application Publication
(10) Pub. No.: US 2008/0158702 A1
(43) Pub. Date: Jul. 3, 2008

(54) Reflecting Mirror

(75) Inventors: Masaaki Nose, Osaka (JP); Akira Tsukamoto, Osaka (JP); Miyuki Teramoto, Osaka (JP); Setsuo Tokuhiro, Tokorozawa-shi (JP)

Correspondence Address: BRINKS HOFER GILSON & LIONE, P.O. BOX 10395, CHICAGO, IL, 60610, US

(73) Assignee: Konica Minolta Opto, Inc.

(21) Appl. No.: 12/004,374

(22) Filed: Dec. 20, 2007

(30) Foreign Application Priority Data
Dec. 27, 2006 (JP) 2006-351064

(51) Int. Cl. G02B 5/08

(52) U.S. Cl. 359/884

(57) ABSTRACT

In a reflecting mirror, an adhesive layer formed of a mixture of silicon dioxide and aluminum oxide is formed between a substrate and an aluminum reflective layer, and, on the aluminum reflective layer, a dielectric layer is formed that has, laid one after another on the aluminum reflective layer, a low-refraction layer containing silicon dioxide and a high-refraction layer formed of a compound of titanium oxide and lanthanum oxide.

This application is based on Japanese Patent Application No. 2006-351064 filed on Dec. 27, 2006, the contents of which are hereby incorporated by reference.

### BACKGROUND OF THE INVENTION

1. Field of the Invention

The present invention relates to a reflecting mirror disposed in an optical path in an optical apparatus such as a camera or a projector, and more particularly to a reflecting mirror suitable for use in an apparatus, such as a projector, that is used in a high-temperature environment.

2. Description of Related Art

Aluminum is used as a reflective material in a reflecting mirror employed in an optical apparatus. Inconveniently, however, aluminum, when used in the form of single-layer film, is poor in mechanical strength, film adhesion, moisture-resistance, and other properties; it is therefore common to lay a protective layer on a reflective layer of aluminum to form multiple-layer film so as to obtain satisfactory mechanical strength, film adhesion, moisture-resistance. For example, U.S. Pat. No. 5,216,551 A1 discloses a technology according to which an oxide primary layer of chromium oxide or the like is formed on a substrate, then a reflective layer of aluminum is formed thereon, and then a protective layer of aluminum oxide is laid further thereon, so as to obtain enhanced film adhesion and moisture-resistance in the substrate and the aluminum reflective layer. Inconveniently, however, a reflecting mirror fabricated according to this conventional technology, when used in the optical path of an optical system in a high-temperature environment as in a projector equipped with a light source, suffers from exfoliation of the aluminum reflective layer from the substrate and opacity resulting from deposition of moisture.

### SUMMARY OF THE INVENTION

The present invention has been devised to address the inconveniences mentioned above, and it is an object of the present invention to provide a reflecting mirror that offers satisfactory film adhesion to a substrate and satisfactory mechanical strength in terms of scratch-resistance and other properties even in a high-temperature environment or in a high-temperature, high-humidity environment.

To achieve the above object, according to the present invention, a reflecting mirror has: a substrate; an adhesive layer formed on the substrate and formed of a mixture of silicon dioxide and aluminum oxide; a reflective layer formed on the adhesive layer and formed of aluminum; and a dielectric layer formed of a low-refraction layer and a high-refraction layer laid one after another on the reflective layer, the low-refraction layer containing silicon dioxide and the high-refraction layer being formed of a mixture of titanium oxide and lanthanum oxide. With this structure, the adhesive layer formed between the substrate and the aluminum reflective layer and formed of a mixture of silicon dioxide and aluminum oxide offers enhanced adhesion, and the low-refraction and high-refraction layers—the former containing silicon dioxide and the latter formed of a mixture of titanium oxide and lanthanum oxide—laid one after another on the aluminum reflective layer offers enhanced film adhesion and scratch-resistance in a high-temperature, high-humidity environment.

### BRIEF DESCRIPTION OF THE DRAWINGS

FIG. 1 is a film structure diagram showing the reflecting mirror of a first embodiment of the invention.

FIG. 2 is a film structure diagram showing the reflecting mirror of a second embodiment of the invention.

FIG. 3 is a film structure diagram showing the reflecting mirror of a third embodiment of the invention.

FIG. 4 is a film structure diagram showing the reflecting mirror of a fourth embodiment of the invention.

FIG. 5 is a graph showing the spectral reflection characteristics of Examples 1 to 8 of the invention.

FIG. 6 is a graph showing the spectral reflection characteristics of Examples 9 to 11 of the invention.

### DETAILED DESCRIPTION OF PREFERRED EMBODIMENTS

Hereinafter, the present invention will be described by way of embodiments with reference to the accompanying drawings. It should be understood that these embodiments are in no way meant to limit the invention. The embodiments are simply intended to show the best mode of carrying out the invention, and the applications of the invention and the terms by which it is described are not limited to those specifically mentioned and used in the description of the embodiments.

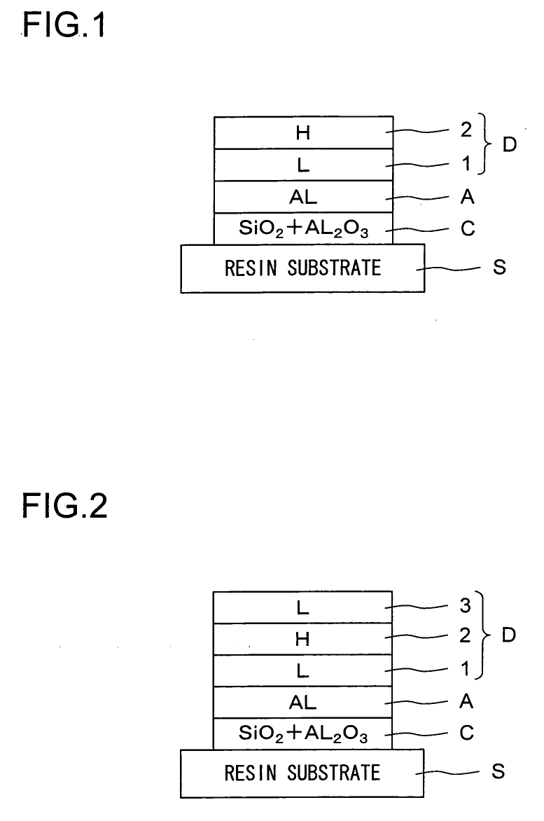

First Embodiment: FIG. 1 is a schematic diagram showing the structure of the reflecting mirror of a first embodiment of the present invention. The reflecting mirror shown in FIG. 1 has the following layers formed on a substrate S formed of synthetic resin: an adhesive layer C formed of a mixture of silicon dioxide and aluminum oxide; a reflective layer A formed of aluminum; and a dielectric layer D having, laid one after the other, a first low-refraction layer 1 formed of a mixture of silicon dioxide and aluminum oxide and a first high-refraction layer 2 formed of a compound of titanium oxide and lanthanum oxide.

The substrate S is formed of polycarbonate resin, polyolefin resin, or norbornene resin.

The adhesive layer C is formed of a mixture of silicon dioxide and aluminum oxide. This helps obtain satisfactory adhesion between the substrate S and the aluminum reflective layer A. Here, when the mixture contains 3 to 10% by mol of aluminum oxide, the aluminum reflective layer A exhibits satisfactory adhesion even in a high-temperature, high-humidity environment. By contrast, if the mixture contains less than 3% by mol of aluminum oxide, poor durability with respect to humidity results, and the aluminum reflective layer A is prone to exfoliation; if the mixture contains more than 10% by mol of aluminum oxide, exfoliation is likely, and the aluminum reflective layer A develops opacity resulting from deposition of moisture.

The reflective layer A is formed of aluminum, and its adequate film thickness is 40 to 200 nm. If the film thickness is less than 40 nm, unsatisfactory reflectivity in the visible light range results; if the film thickness is more than 200 nm, membrane stress causes pinholes. More preferably, the film thickness is 40 to 100 nm. The preferred thickness of the reflective layer A applies equally to all the following embodiments.

The dielectric layer D is formed of two layers, namely a first low-refraction layer 1 and a first high-refraction layer 2, and serves to enhance the reflectivity of the reflective layer A. The first low-refraction layer 1 is formed of a mixture of silicon dioxide and aluminum oxide, and the first high-refraction layer 2 is formed of a compound of titanium oxide and lanthanum oxide. This prevents moisture outside from reaching the reflective layer A, and also helps enhance the film hardness to reduce susceptibility to scratches. Preferably, the mixture of which the first low-refraction layer 1 is formed contains 3 to 10% by mol of aluminum oxide, and the compound of which the first high-refraction layer 2 is formed contains lanthanum and titanium in a ratio of 1:1 and has the composition La₂Ti₂Oₓ(x=6.3 to 6.7). The first low-refraction layer 1 may be formed solely of silicon dioxide.

In this reflecting mirror, the optical film thicknesses of the individual layers are as follows. The adhesive layer C has an optical film thickness of 0.16 to 4; in the dielectric layer D, the first low-refraction layer 1 has an optical film thickness of 0.16 to 2, and the first high-refraction layer 2 has an optical film thickness of 0.16 to 2. Throughout the present specification, optical film thicknesses are expressed in units of (as multiples of) 4nd/λ, where n represents index of refraction, d represents film thickness, and λ represents reference wavelength, namely 550 nm. If the optical film thickness of the adhesive layer C is less than 0.16, unsatisfactory adhesion results, and the adhesive layer C has an uneven film thickness; moreover, the reflective layer A formed thereon has poor flatness. If the optical film thickness of the adhesive layer C is more than 4, membrane stress is so large that the film develops cracks in a high-temperature environment, and its formation takes a long time, leading to low productivity. When the optical film thicknesses of the first low-refraction layer 1 and the first high-refraction layer 2 are within the defined numerical ranges, high reflectivity is obtained. If the optical film thickness of the first low-refraction layer 1 is less than 0.16, an uneven film thickness results; if the optical film thickness of the first low-refraction layer 1 is more than 2, cracks develop in the surface in a high-temperature environment. If the optical film thickness of the first high-refraction layer 2 is less than 0.16, an uneven film thickness results; if the optical film thickness of the first high-refraction layer 2 is more than 2, cracks develop in the surface in a high-temperature environment. More preferably, the adhesive layer C has an optical film thickness of 0.6 to 1.4, the first low-refraction layer 1 has an optical film thickness of 0.6 to 1.4, and the first high-refraction layer 2 has an optical film thickness of 0.6 to 1.4.

This reflecting mirror is fabricated as follows. The substrate S is placed inside a vacuum chamber, and, on this substrate S, silicon dioxide and aluminum oxide are deposited by electron beam evaporation to form the adhesive layer C. Then aluminum is deposited by resistance heating evaporation to form the reflective layer A. Then, by electron beam evaporation, silicon dioxide and aluminum oxide are deposited to form the first low-refraction layer 1, and then, further thereon, titanium oxide and lanthanum oxide are deposited to form the first high-refraction layer 2. These layers may be formed by any film formation method other than electron beam evaporation and resistance heating evaporation, for example, by sputtering or the like. They may also be formed by ion assist evaporation, which involves supplying ions from an ion source into a vacuum chamber, or by a plasma process, which achieves film formation in an atmosphere of plasma produced inside a vacuum chamber. Ion assist evaporation and a plasma process help form more closely packed layers, and are expected to lead to increased reliability.

Second Embodiment: FIG. 2 is a schematic diagram showing the structure of the reflecting mirror of a second embodiment of the present invention. The following description focuses on the dielectric layer D, which is formed differently here than in the first embodiment, and no description will be repeated of such parts as find their counterparts in the first embodiment.

Compared with the dielectric layer D of the first embodiment, which is formed of a first low-refraction layer 1 and a first high-refraction layer 2, the dielectric layer D here further has, laid on the first high-refraction layer 2, a second low-refraction layer 3, which is thus the topmost layer.

The second low-refraction layer 3 is formed of a mixture of silicon dioxide and aluminum oxide, and the mixture contains 3 to 10% by mol of aluminum oxide. The second low-refraction layer 3 has an optical film thickness of 0.11 to 3. When the optical film thickness is 0.11 or more, enhanced resistance to solvents is obtained, and the surface is less susceptible to scratches. If the optical film thickness is more than 3, cracks are likely to develop in a high-temperature environment. The second low-refraction layer 3 may be formed solely of silicon dioxide. More preferably, the second low-refraction layer 3 has an optical film thicknesses of 0.16 to 0.5. The optical film thicknesses of the other layers are the same as in the first embodiment, and are specifically as follows. The adhesive layer C has an optical film thickness of 0.16 to 4; in the dielectric layer D, the first low-refraction layer 1 has an optical film thickness of 0.16 to 2, and the first high-refraction layer 2 has an optical film thickness of 0.16 to 2. More preferably, the adhesive layer C has an optical film thickness of 0.6 to 1.4, the first low-refraction layer 1 has an optical film thickness of 0.6 to 1.4, and the first high-refraction layer 2 has an optical film thickness of 0.6 to 1.4.

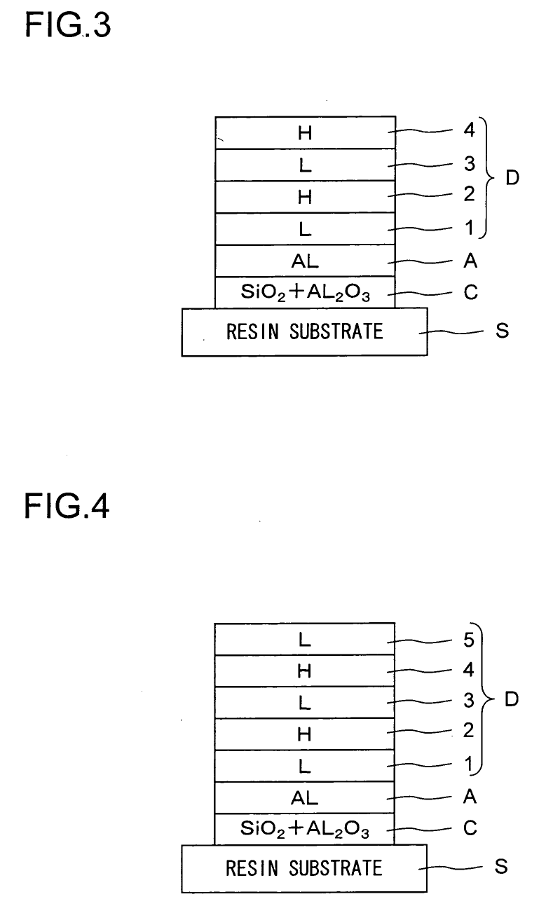

Third Embodiment: FIG. 3 is a schematic diagram showing the structure of the reflecting mirror of a third embodiment of the present invention. In the third embodiment, the dielectric layer D is formed differently than in the first embodiment, and is specifically formed of four layers, namely a first low-refraction layer 1, a first high-refraction layer 2, a second low-refraction layer 3, and a second high-refraction layer 4. This helps further enhance the reflectivity of the reflective layer A. The optical film thicknesses of the individual layers are as follows. The adhesive layer C has an optical film thickness of 0.16 to 4; the first low-refraction layer 1 has an optical film thickness of 0.16 to 2; the first high-refraction layer 2 has an optical film thickness of 0.16 to 2; the second low-refraction layer 3 has an optical film thickness of 0.16 to 2; the second high-refraction layer 4 has an optical film thickness of 0.16 to 2.5. This brings benefits similar to those obtained with the first embodiment. More preferably, the adhesive layer C has an optical film thickness of 0.6 to 1.4, the first low-refraction layer 1 has an optical film thickness of 0.6 to 1.4, the first high-refraction layer 2 has an optical film thickness of 0.6 to 1.4, and the second high-refraction layer 4 has an optical film thickness of 0.23 to 1.4.

Fourth Embodiment: FIG. 4 is a schematic diagram showing the structure of the reflecting mirror of a fourth embodiment of the present invention. In the film structure of the fourth embodiment, compared with that of the third embodiment, a third low-refraction layer 5 is additionally formed as the topmost layer. The optical film thickness of the third low-refraction layer 5 is 0.11 to 3. This structure helps further reduce susceptibility to scratches and enhance reflectivity. More preferably, the third low-refraction layer 5 has an optical film thickness of 0.16 to 0.5. The optical film thicknesses of the adhesive layer C and of the layers of the dielectric layer D below the third low-refraction layer 5 are the same as in the third embodiment, and are specifically as follows. The first low-refraction layer 1 has an optical film thickness of 0.16 to 2; the first high-refraction layer 2 has an optical film thickness of 0.16 to 2; the second low-refraction layer 3 has an optical film thickness of 0.16 to 2; the second high-refraction layer 4 has an optical film thickness of 0.16 to 2.5. More preferably, the adhesive layer C has an optical film thickness of 0.6 to 1.4, the first low-refraction layer 1 has an optical film thickness of 0.6 to 1.4, the first high-refraction layer 2 has an optical film thickness of 0.6 to 1.4, the second low-refraction layer 3 has an optical film thickness of 0.6 to 1.4; and the second high-refraction layer 4 has an optical film thickness of 0.23 to 1.4.

### EXAMPLES

Hereinafter, as more specific examples of implementation of the present invention, Practical Examples 1 to 11, shown in Table 1, will be presented in comparison with Comparative Examples 1 to 6, shown in Table 2. Here, the materials are assumed to be as follows: TiO₂+La₂O₃ represents a compound of titanium oxide and lanthanum oxide having the composition La₂Ti₂Oₓ(x=6.3 to 6.7); SiO₂+Al₂O₃ represents a mixture of silicon dioxide and aluminum oxide; Al represents aluminum; SiO₂ represents silicon dioxide; TiO₂+Ta₂O₅ represents a mixture of titanium oxide and tantalum oxide; and TiO₂ represents titanium oxide.

In the reflecting mirror of Practical Example 1, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer) and a layer of the compound La₂Ti₂Oₓ(x=6.3 to 6.7) (a high-refraction layer).

In the reflecting mirror of Practical Example 2, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of the compound La₂Ti₂Oₓ(x=6.3 to 6.7) (a high-refraction layer), and a layer of a mixture of 95% by mol of silicon dioxide and 5% by mol of aluminum oxide (a low-refraction layer).

In the reflecting mirror of Practical Example 3, on a substrate of polycarbonate resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of the compound La₂Ti₂Oₓ(x=6.3 to 6.7) (a high-refraction layer), and a layer of a mixture of 95% by mol of silicon dioxide and 5% by mol of aluminum oxide (a low-refraction layer).

In the reflecting mirror of Practical Example 4, on a substrate of polyolefin resin, a layer of a mixture of 90% by mol of silicon dioxide and 10% by mol of aluminum oxide is formed (an adhesive layer). On the adhesive layer, a reflective layer of aluminum is formed. On the reflective layer, a dielectric layer is formed that is formed of, from the substrate side thereof, a layer of silicon dioxide (a low-refraction layer), a layer of the compound La₂Ti₂Oₓ (x=6.3 to 6.7) (a high-refraction layer), and a layer of silicon dioxide (a low-refraction layer).

In the reflecting mirror of Practical Example 5, on a substrate of polyolefin resin, a layer of a mixture of 97% by mol of silicon dioxide and 3% by mol of aluminum oxide is formed (an adhesive layer). On the adhesive layer, a reflective layer of aluminum is formed. On the reflective layer, a dielectric layer is formed that is formed of, from the substrate side thereof, a layer of silicon dioxide (a low-refraction layer), a layer of the compound La₂Ti₂Oₓ (x=6.3 to 6.7) (a high-refraction layer), and a layer of silicon dioxide (a low-refraction layer).

In the reflecting mirror of Practical Example 6, on a substrate of norbornene resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of the compound La₂Ti₂Oₓ (x=6.3 to 6.7) (a high-refraction layer), and a layer of a mixture of 95% by mol of silicon dioxide and 5% by mol of aluminum oxide (a low-refraction layer).

In the reflecting mirror of Practical Example 7, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of silicon dioxide (a low-refraction layer), a layer of the compound La₂Ti₂Oₓ (x=6.3 to 6.7) (a high-refraction layer), and a layer of silicon dioxide (a low-refraction layer).

In the reflecting mirror of Practical Example 8, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of the compound La₂Ti₂Oₓ (x=6.3 to 6.7) (a high-refraction layer), a layer of a mixture of 95% by mol of silicon dioxide and 5% by mol of aluminum oxide (a low-refraction layer), and a layer of the compound La₂Ti₂Oₓ (x=6.3 to 6.7) (a high-refraction layer).

In the reflecting mirrors of Practical Examples 9 to 11, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of the compound La₂Ti₂Oₓ (x=6.3 to 6.7) (a high-refraction layer), a layer of a mixture of 95% by mol of silicon dioxide and 5% by mol of aluminum oxide (a low-refraction layer), a layer of the compound La₂Ti₂Oₓ (x=6.3 to 6.7) (a high-refraction layer), and a layer of a mixture of 95% by mol of silicon dioxide and 5% by mol of aluminum oxide (a low-refraction layer). Practical Examples 9 to 11 differ in the film thickness the topmost, low-refraction layer.

Next, the film structures of comparative examples will be described. In the reflecting mirror of Comparative Example 1, on a substrate of polyolefin resin, a layer of silicon dioxide is formed (an adhesive layer). On the adhesive layer, a reflective layer of aluminum is formed. On the reflective layer, a dielectric layer is formed that is formed of, from the substrate side thereof, a layer of silicon dioxide (a low-refraction layer), a layer of a compound of titanium oxide and lanthanum oxide (a high-refraction layer), and a layer of silicon dioxide (a low-refraction layer).

In the reflecting mirror of Comparative Example 2, on a substrate of polyolefin resin, a layer of aluminum oxide is formed (an adhesive layer). On the adhesive layer, a reflective layer of aluminum is formed. On the reflective layer, a dielectric layer is formed that is formed of, from the substrate side thereof, a layer of silicon dioxide (a low-refraction layer), a layer of a mixture of titanium oxide and lanthanum oxide (a high-refraction layer), and a layer of silicon dioxide (a low-refraction layer).

In the reflecting mirror of Comparative Example 3, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of a mixture of titanium oxide and lanthanum oxide (a high-refraction layer), and a layer of a mixture of 95% by mol of silicon dioxide and 5% by mol of aluminum oxide (a low-refraction layer).

In the reflecting mirror of Comparative Example 4, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of titanium oxide (a high-refraction layer), and a layer of a mixture of 95% by mol of silicon dioxide and 5% by mol of aluminum oxide (a low-refraction layer).

In the reflecting mirror of Comparative Example 5, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of titanium oxide (a high-refraction layer), a layer of a mixture of 95% by mol of silicon dioxide and 5% by mol of aluminum oxide (a low-refraction layer), and a layer of titanium oxide (a high-refraction layer).

In the reflecting mirror of Comparative Example 6, on a substrate of polyolefin resin, a layer of a mixture of 95% by mol of silicon dioxide and 5% by mol of aluminum oxide is formed (an adhesive layer). On the adhesive layer, a reflective layer of aluminum is formed. On the reflective layer, a dielectric layer is formed that is formed of, from the substrate side thereof, a layer of a mixture of 95% by mol of silicon dioxide and 5% by mol of aluminum oxide (a low-refraction layer), a layer of titanium oxide (a high-refraction layer), a layer of a mixture of 95% by mol of silicon dioxide and 5% by mol of aluminum oxide (a low-refraction layer), a layer of titanium oxide (a high-refraction layer), and a layer of a mixture of 95% by mol of silicon dioxide and 5% by mol of aluminum oxide (a low-refraction layer).

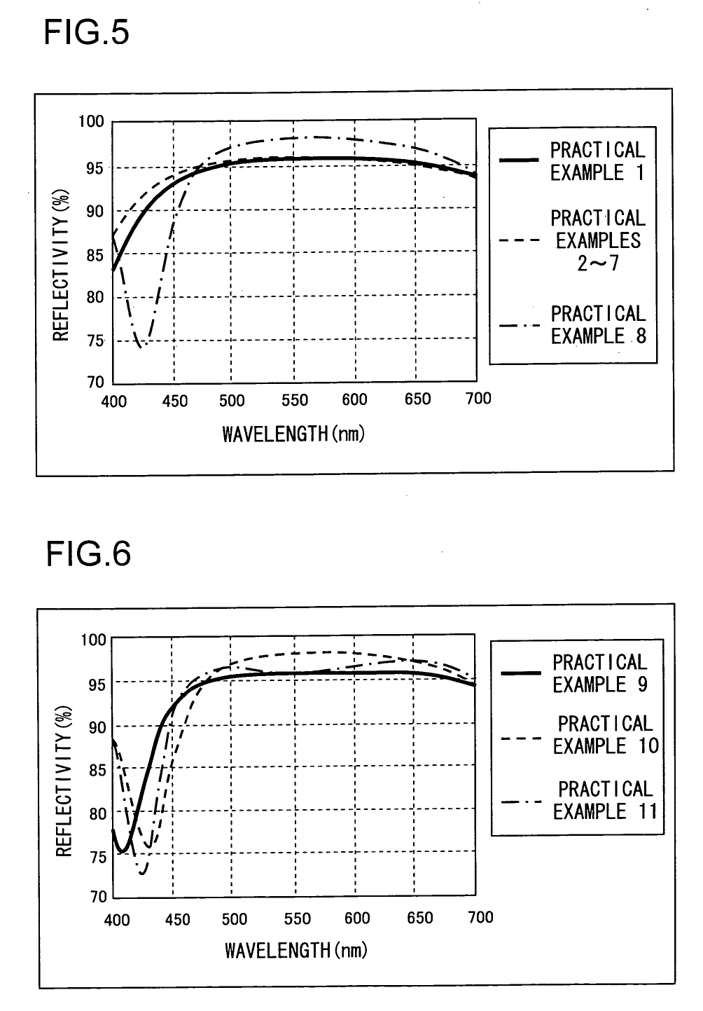

The spectral reflectivity characteristics of Practical Examples 1 to 11 according to the present invention are shown in FIGS. 5 and 6, and the evaluation results of these examples are shown in Table 3. The evaluation results of Comparative Examples 1 to 6 are shown in Table 4.

The tests conducted to evaluate the different aspects listed in Tables 3 and 4 were as follows. The appearance was evaluated through a visual check of the degree of scratches and opacity. The adhesion was evaluated by applying a piece of adhesive tape (“L Pack” manufactured by Nichiban) to the film under the finger cushion and then, while removing it, feeling the degree of adhesion of the film to the substrate. The resistance to solvents was evaluated by wiping the surface of the sample with a piece of cleaning paper or cotton moistened with a solvent, such as neutral detergent (diluted to ten parts), ethyl alcohol, isopropyl alcohol, or lens cleaning fluid, under a load of 200 g, at a speed of 60 mm per second, and 50 round trips over a stroke of 30 mm, and then checking for changes in the sample. In these three aspects, the film was evaluated at room temperature. The tests for resistance to different environmental conditions were conducted as follows. The heat-cycle test involved repeating 144 cycles of first leaving the sample at −20° C. for 20 minutes and then leaving it at 80° C. for 20 minutes. The test for moisture resistance involved leaving the sample in an atmosphere of 40° C., 90% RH for 170 hours, and the test for heat resistance involved leaving the sample in an atmosphere of 80° C. for 170 hours. The salt water spray test (MIL-M-13508C) involved keeping the sample sprayed with salt water of a concentration of 5% in an atmosphere of 35° C. for 24 hours; the test for weather resistance involved leaving the sample in a Fade-O-meter for 200 hours; the high-temperature, high-humidity test involves leaving the sample in an atmosphere of 60° C., 90% RH for three days. In these tests for resistance to different environmental conditions, after each test, the appearance, such as opacity, and the adhesion were evaluated. The evaluation results are shown in Tables 3 and 4, where “GOOD” denotes “satisfactory”, “FAIR” denotes “largely satisfactory, with minimal defects (acceptable in practical terms), and “POOR” denotes “unacceptably defective in practical terms”.

As will be clearly understood from Tables 3 and 4, among the practical examples according to the present invention, only Practical Examples 1 and 8 had a minimal defect but still were found acceptable in practical terms; all the other practical examples proved satisfactory in all items of evaluation. In contrast, the comparative examples were found defective in many items of evaluation—solvent resistance, heat resistance, salt water spray, weather resistance, and high temperature combined with high humidity, and proved unacceptably defective in practical terms.

TABLE 1

| Practical | | Index of Refraction | Film Thickness | Optical Film |
|---|---|---|---|---|
| Example | Material | (n: λ 550 nm) | d (nm) | Thickness (QWOT) |
| 1 | TiO₂ + La₂O₃ | 1.95 | 70.5 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 2 | SiO₂ + Al₂O₃ | 1.48 | 10.2 | 0.11 |
| | TiO₂ + La₂O₃ | 1.95 | 70.5 | 1.00 |
| | SiO₂ + Al₂O₃ | 1.48 | 83.6 | 0.90 |
| | AL | | 70.0 | |
| | SiO₂ + Al₂O₃ | 1.48 | 92.9 | 1.00 |
| 3 | SiO₂ + Al₂O₃ | 1.48 | 10.2 | 0.11 |
| | TiO₂ + La₂O₃ | 1.95 | 70.5 | 1.00 |
| | SiO₂ + Al₂O₃ | 1.48 | 83.6 | 0.90 |
| | AL | | 70.0 | |
| | SiO₂ + Al₂O₃ | 1.48 | 92.9 | 1.00 |
| 4 | SiO₂ | 1.46 | 10.4 | 0.11 |
| | TiO₂ + La₂O₃ | 1.95 | 70.5 | 1.00 |
| | SiO₂ | 1.46 | 84.8 | 0.90 |
| | AL | | 70.0 | |
| | SiO₂ + Al₂O₃ | 1.48 | 92.9 | 1.00 |
| 5 | SiO₂ | 1.46 | 10.4 | 0.11 |
| | TiO₂ + La₂O₃ | 1.95 | 70.5 | 1.00 |
| | SiO₂ | 1.46 | 84.8 | 0.90 |
| | AL | | 70.0 | |
| | SiO₂ + Al₂O₃ | 1.48 | 92.9 | 1.00 |
| 6 | SiO₂ + Al₂O₃ | 1.48 | 10.2 | 0.11 |
| | TiO₂ + La₂O₃ | 1.95 | 70.5 | 1.00 |
| | SiO₂ + Al₂O₃ | 1.48 | 83.6 | 0.90 |
| | AL | | 70.0 | |
| | SiO₂ + Al₂O₃ | 1.48 | 92.9 | 1.00 |
| 7 | SiO₂ | 1.46 | 10.4 | 0.11 |
| | TiO₂ + La₂O₃ | 1.95 | 70.5 | 1.00 |
| | SiO₂ | 1.46 | 84.8 | 0.90 |
| | AL | | 70.0 | |
| | SiO₂ + Al₂O₃ | 1.48 | 92.9 | 1.00 |
| 8 | TiO₂ + La₂O₃ | 1.95 | 70.5 | 1.00 |
| | SiO₂ + Al₂O₃ | 1.48 | 92.9 | 1.00 |
| | TiO₂ + La₂O₃ | 1.95 | 70.5 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 9 | SiO₂ + Al₂O₃ | 1.48 | 92.9 | 1.00 |
| | TiO₂ + La₂O₃ | 1.95 | 70.5 | 1.00 |
| | SiO₂ + Al₂O₃ | 1.48 | 92.9 | 1.00 |
| | TiO₂ + La₂O₃ | 1.95 | 70.5 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 10 | SiO₂ + Al₂O₃ | 1.48 | 10.2 | 0.11 |
| | TiO₂ + La₂O₃ | 1.95 | 70.5 | 1.00 |
| | SiO₂ + Al₂O₃ | 1.48 | 92.9 | 1.00 |
| | TiO₂ + La₂O₃ | 1.95 | 70.5 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 11 | SiO₂ + Al₂O₃ | 1.48 | 278.7 | 3.00 |
| | TiO₂ + La₂O₃ | 1.95 | 70.5 | 1.00 |
| | SiO₂ + Al₂O₃ | 1.48 | 92.9 | 1.00 |
| | TiO₂ + La₂O₃ | 1.95 | 70.5 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 12 | SiO₂ + Al₂O₃ | 1.48 | 10.2 | 0.11 |
| | TiO₂ + La₂O₃ | 1.95 | 70.5 | 1.00 |
| | SiO₂ + Al₂O₃ | 1.48 | 83.6 | 0.90 |
| | AL | | 70.0 | |
| | SiO₂ + Al₂O₃ | 1.48 | 92.9 | 1.00 |

TABLE 2

| Comparative | | Index of Refraction | Film Thickness | Optical Film |
|---|---|---|---|---|
| Example | Material | (n: λ 550 nm) | d (nm) | Thickness (QWOT) |
| 1 | SiO₂ | 1.46 | 28.3 | 0.30 |
| | TiO₂ + La₂O₃ | 1.95 | 70.5 | 1.00 |
| | SiO₂ | 1.46 | 94.2 | 1.00 |
| | AL | | 70.0 | |
| | SiO₂ | 1.46 | 94.2 | 1.00 |
| 2 | SiO₂ | 1.46 | 28.3 | 0.30 |
| | TiO₂ + La₂O₃ | 1.95 | 70.5 | 1.00 |
| | SiO₂ | 1.46 | 94.2 | 1.00 |
| | AL | | 70.0 | |
| | AL₂O₃ | 1.6 | 85.9 | 1.00 |
| 3 | SiO₂ + Al₂O₃ | 1.48 | 27.9 | 0.30 |
| | TiO₂ + Ta₂O₅ | 1.97 | 69.8 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 4 | SiO₂ + Al₂O₃ | 1.48 | 27.9 | 0.30 |
| | TiO₂ | 2.19 | 62.8 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 5 | TiO₂ | 2.19 | 62.8 | 1.00 |
| | SiO₂ + Al₂O₃ | 1.48 | 92.9 | 1.00 |
| | TiO₂ | 2.19 | 62.8 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |
| 6 | SiO₂ + Al₂O₃ | 1.48 | 27.9 | 0.30 |
| | TiO₂ | 2.19 | 62.8 | 1.00 |
| | SiO₂ + Al₂O₃ | 1.48 | 92.9 | 1.00 |
| | TiO₂ | 2.19 | 62.8 | 1.00 |
| | SiO₂ + Al₂O₃ | 1.48 | 92.9 | 1.00 |
| | AL | | 70.0 | |
| | SiO₂ + Al₂O₃ | 1.48 | 92.9 | 1.00 |

TABLE 3

| | | | Practical Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Appearance | | | GOOD | GOOD | GOOD | GOOD | GOOD | GOOD | GOOD | GOOD | GOOD | GOOD | GOOD |
| Adhesion | | | GOOD | GOOD | GOOD | GOOD | GOOD | GOOD | GOOD | GOOD | GOOD | GOOD | GOOD |
| Solvent Resistance | | | FAIR | GOOD | GOOD | GOOD | GOOD | GOOD | GOOD | FAIR | GOOD | GOOD | GOOD |
| Environmental | Heat | Appearance | GOOD | GOOD | GOOD | GOOD | GOOD | GOOD | GOOD | GOOD | GOOD | GOOD | GOOD |
| Conditions | Cycle | Adhesion | GOOD | GOOD | GOOD | GOOD | GOOD | GOOD | GOOD | GOOD | GOOD | GOOD | GOOD |
| | Moisture | Appearance | GOOD | GOOD | GOOD | GOOD | GOOD | GOOD | GOOD | GOOD | GOOD | GOOD | GOOD |
| | Resistance | Adhesion | GOOD | GOOD | GOOD | GOOD | GOOD | GOOD | GOOD | GOOD | GOOD | GOOD | GOOD |
| | Heat | Appearance | GOOD | GOOD | GOOD | GOOD | GOOD | GOOD | GOOD | GOOD | GOOD | GOOD | GOOD |
| | Resistance | Adhesion | GOOD | GOOD | GOOD | GOOD | GOOD | GOOD | GOOD | GOOD | GOOD | GOOD | GOOD |
| | Salt Water | Appearance | GOOD | GOOD | GOOD | GOOD | GOOD | GOOD | GOOD | GOOD | GOOD | GOOD | GOOD |
| | Spraying | Adhesion | GOOD | GOOD | GOOD | GOOD | GOOD | GOOD | GOOD | GOOD | GOOD | GOOD | GOOD |
| | Weather | Appearance | GOOD | GOOD | GOOD | GOOD | GOOD | GOOD | GOOD | GOOD | GOOD | GOOD | GOOD |
| | Resistance | Adhesion | GOOD | GOOD | GOOD | GOOD | GOOD | GOOD | GOOD | GOOD | GOOD | GOOD | GOOD |
| | High | Appearance | GOOD | GOOD | GOOD | GOOD | GOOD | GOOD | GOOD | GOOD | GOOD | GOOD | GOOD |
| | Temperature | Adhesion | GOOD | GOOD | GOOD | GOOD | GOOD | GOOD | GOOD | GOOD | GOOD | GOOD | GOOD |
| | & Humidity | | | | | | | | | | | | |

TABLE 4

| | | | Comparative Example | | | | | |
|---|---|---|---|---|---|---|---|---|
| | | | 1 | 2 | 3 | 4 | 5 | 6 |
| Appearance | | | GOOD | GOOD | GOOD | GOOD | GOOD | GOOD |
| Adhesion | | | GOOD | GOOD | GOOD | GOOD | GOOD | GOOD |
| Solvent Resistance | | | GOOD | GOOD | GOOD | GOOD | POOR | GOOD |
| Environmental | Heat | Appearance | GOOD | GOOD | GOOD | GOOD | GOOD | GOOD |
| Conditions | Cycle | Adhesion | GOOD | GOOD | GOOD | GOOD | GOOD | GOOD |
| | Moisture | Appearance | GOOD | GOOD | GOOD | GOOD | GOOD | GOOD |
| | Resistance | Adhesion | GOOD | GOOD | GOOD | GOOD | GOOD | GOOD |
| | Heat | Appearance | POOR | POOR | GOOD | GOOD | FAIR | FAIR |
| | Resistance | Adhesion | POOR | POOR | GOOD | GOOD | FAIR | FAIR |
| | Salt Water | Appearance | GOOD | GOOD | FAIR | FAIR | FAIR | FAIR |
| | Spraying | Adhesion | GOOD | GOOD | POOR | POOR | POOR | POOR |
| | Weather | Appearance | GOOD | GOOD | FAIR | FAIR | FAIR | FAIR |
| | Resistance | Adhesion | GOOD | GOOD | POOR | POOR | POOR | POOR |
| | High Temperature | Appearance | POOR | POOR | GOOD | GOOD | GOOD | GOOD |
| | & Humidity | Adhesion | POOR | POOR | GOOD | GOOD | GOOD | GOOD |

What is claimed is:

1. A reflecting mirror comprising:
a substrate;
an adhesive layer formed on the substrate and formed of a mixture of silicon dioxide and aluminum oxide;
a reflective layer formed on the adhesive layer and formed of aluminum; and
a dielectric layer formed of a low-refraction layer and a high-refraction layer laid one after another on the reflective layer, the low-refraction layer containing silicon dioxide and the high-refraction layer being formed of a compound of titanium oxide and lanthanum oxide.

2. The reflecting mirror of claim 1, wherein
the mixture of which the adhesive layer is formed contains 3 to 10% by mol of aluminum oxide.

3. The reflecting mirror of claim 1, wherein
the substrate is formed of polycarbonate resin, polyolefin resin, or norbomene resin.

4. The reflecting mirror of claim 1, wherein
the dielectric layer is formed of, from a substrate side thereof, a first low-refraction layer and a first high-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2, and
the first high-refraction layer has an optical film thickness of 0.16 to 2.

5. The reflecting mirror of claim 1, wherein
the dielectric layer is formed of, from a substrate side thereof, a first low-refraction layer, a first high-refraction layer, and a second low-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2,
the first high-refraction layer has an optical film thickness of 0.16 to 2, and
the second low-refraction layer has an optical film thickness of 0.11 to 3.

6. The reflecting mirror of claim 1, wherein
the dielectric layer is formed of, from a substrate side thereof, a first low-refraction layer, a first high-refraction layer, a second low-refraction layer, and a second high-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2,
the first high-refraction layer has an optical film thickness of 0.16 to 2,
the second low-refraction layer has an optical film thickness of 0.16 to 2, and
the second high-refraction layer has an optical film thickness of 0.16 to 2.5.

7. The reflecting mirror of claim 1, wherein
the dielectric layer is formed of, from a substrate side thereof, a first low-refraction layer, a first high-refraction layer, a second low-refraction layer, a second high-refraction layer, and a third low-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2,
the first high-refraction layer has an optical film thickness of 0.16 to 2,
the second low-refraction layer has an optical film thickness of 0.16 to 2, and
the second high-refraction layer has an optical film thickness of 0.16 to 2.5, and
the third low-refraction layer has an optical film thickness of 0.11 to 3.

8. The reflecting mirror of claim 1, wherein
the reflecting mirror is used in a projector.

9. A reflecting mirror comprising:
a substrate formed of polycarbonate resin, polyolefin resin, or norbomene resin;
an adhesive layer formed on the substrate and formed of a mixture of silicon dioxide and aluminum oxide, the mixture containing 3 to 10% by mol of aluminum oxide;
a reflective layer formed on the adhesive layer and formed of aluminum; and
a dielectric layer formed of a low-refraction layer and a high-refraction layer laid one after another on the reflective layer, the low-refraction layer containing silicon dioxide and the high-refraction layer being formed of a compound of titanium oxide and lanthanum oxide.

10. The reflecting mirror of claim 9, wherein
the dielectric layer is formed of, from a substrate side thereof, a first low-refraction layer and a first high-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2, and
the first high-refraction layer has an optical film thickness of 0.16 to 2.

11. The reflecting mirror of claim 9, wherein
the dielectric layer is formed of, from a substrate side thereof, a first low-refraction layer, a first high-refraction layer, and a second low-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2,
the first high-refraction layer has an optical film thickness of 0.16 to 2, and
the second low-refraction layer has an optical film thickness of 0.11 to 3.

12. The reflecting mirror of claim 9, wherein
the dielectric layer is formed of, from a substrate side thereof, a first low-refraction layer, a first high-refraction layer, a second low-refraction layer, and a second high-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2,
the first high-refraction layer has an optical film thickness of 0.16 to 2,
the second low-refraction layer has an optical film thickness of 0.16 to 2, and
the second high-refraction layer has an optical film thickness of 0.16 to 2.5.

13. The reflecting mirror of claim 9, wherein
the dielectric layer is formed of, from a substrate side thereof, a first low-refraction layer, a first high-refraction layer, a second low-refraction layer, a second high-refraction layer, and a third low-refraction layer, and
in terms of optical film thickness in units of 4nd/λ, where n represents index of refraction, d represents film thickness, and λ represents reference wavelength, namely 550 nm,
the adhesive layer has an optical film thickness of 0.16 to 4,
the first low-refraction layer has an optical film thickness of 0.16 to 2,
the first high-refraction layer has an optical film thickness of 0.16 to 2,
the second low-refraction layer has an optical film thickness of 0.16 to 2, and
the second high-refraction layer has an optical film thickness of 0.16 to 2.5, and
the third low-refraction layer has an optical film thickness of 0.11 to 3.

14. The reflecting mirror of claim 9, wherein
the reflecting mirror is used in a projector.
